(19) United States
(12) Patent Application Publication
(10) Pub. No.: US 2012/0244812 A1
(43) Pub. Date: Sep. 27, 2012

(54) Automatic Sensory Data Routing Based On Worn State

(75) Inventor: Douglas K. Rosener, Santa Cruz, CA (US)

(73) Assignee: Plantronics, Inc., Santa Cruz, CA (US)

(21) Appl. No.: 13/072,719

(22) Filed: Mar. 27, 2011

(51) Int. Cl. H04B 7/00

(52) U.S. Cl. 455/41.3

(57) ABSTRACT

A system and method for automatically routing sensory data, such as audio communications, to peripheral devices, such as headsets, from host devices, such as mobile phones, is described. The peripheral devices employ Don/Doff sensors whose status directs the flow of sensory information (e.g., audio information) between the peripheral device (e.g., the headset) and the host device (e.g., a mobile phone). In alternative embodiments, a proximity sensor in the host device may supplement or enhance the flow of sensory information between the host device and the peripheral device.

### FIELD

Embodiments of the invention relate to systems and methods for communications among the devices in a network. More particularly, an embodiment of the invention relates to systems and methods that detect a user wearing state and automatically route sensory data in the network based upon the wearing state.

### BACKGROUND

Headset users have long suffered from having audio outputs directed on occasion to the wrong location. Sometimes the headset user has taken his headset off, only to discover that incoming audio is still being sent to the headset; likewise headset users have sometimes donned their headsets only to find that the audio for some applications is still being sent to the speakers associated with a handset, computer, or speakerphone. Audio communications, regardless of context, should be audible to their intended recipient in the preferred manner. Similarly, the output of all sensory information potentially directed to peripheral devices should arrive at the intended device in the preferred manner.

Attempts to solve this longstanding problem in the prior art have tended to be overly simplistic, overly complicated, and/or overly expensive. For example, one of the preferred solutions in the prior art has been to automatically push audio data to a user's headset once the headset has been connected to the mobile phone. This automatic audio push is the reason why users who have taken off their headsets, and possibly even stored them someplace, often discover that an incoming call produces no audio on their mobile phone.

FIG. 1 Illustrates a conventional prior art system 100 for controlling the flow of audio output/input between a headset 102 and a mobile phone 101. The mobile phone 101 includes a transceiver 104 that is configured for communications 106, 107 with a transceiver 105 on the headset 102. The communications 106, 107 may utilize a conventional protocol, such as Bluetooth. In some configurations, once the transceiver 105 communicates with the transceiver 104, then an audio controller 103 in the mobile phone 101 directs future audio output to the headset 102. In other embodiments, a user associated with the mobile phone 101 may also need to instruct the audio controller 103 to direct future audio output to the headset 102.

Regardless of the specific configuration, prior art systems typically maintain automatic routing of audio output to the headset 102 so long as the transceivers 104, 105 can communicate between the mobile phone 101 and the headset 102 and so long as the user takes no affirmative steps to terminate the connection. This communications paradigm operates in a similar manner when the mobile phone 101 is replaced with a speakerphone, a wired telephone, or a computer, as well as many other devices configured for outputting audio.

On some occasions, a user may have connected the headset 102 to the mobile phone 101 long before the user receives a call on the mobile phone 101. In some instances, the user may have even connected the mobile phone 101 to the headset 102 a day or even several days prior to receiving an incoming call. In the intervening period, the user may have removed the headset 102 from his head. The user, forgetting about the connection between the mobile phone 101 and the headset 102, and/or being unable to find the headset 102, answers the call only to discover that he has no audio on the mobile phone 101. The user may believe that the mobile phone 101 is malfunctioning and might possibly even hang up. Even if the user remembers that the mobile phone 101 is connected to the headset 102 and makes corrections before the call terminates, the user may still appear bumbling and unprofessional to the party who placed the call. The situation can be even more embarrassing for the user when the user is the one who placed the call.

In other situations, the user might activate a music player, or another application, on the mobile phone 101 only discover that he has no audio. Again, the user may be able to make corrections, but he will have missed at least a portion of the selected song before correction can be made.

Similarly, the situation may occur in the reverse. The user may want to use his headset 102 for a call or to listen to music only to have an interface on the mobile phone 101 that essentially causes him to terminate the call or turn off the application as part of the process of connecting the headset 102 to the mobile phone 101. Other prior art solutions may require the user to press a button on a device (e.g., the mobile phone 101) to force the audio to a given speaker system (speakerphone, handset ear audio, or headset audio). This is the sort of action that may involve, for example, the audio controller 103. For example, the mobile phone 101 may have a button to choose a new audio source, e.g., a button that connects to the audio controller 103. Similarly, the headset 102 might have a button that when pressed, would switch audio to the headset 102.

Unified communications represents an important component of productivity in contemporary business culture, and its success from company to company can serve as a bellwether indicator of the company's overall management success. An essential feature behind unified communications is the ability to have a single way for reaching an employee. Thus, in a fully configured unified communications environment, all messages to an employee, regardless of the format of their origin (e.g., e-mail) will reach the employee at the earliest possible moment via another format (e.g., SMS) if necessary. The importance of appropriate audio communications in a unified communications context cannot be understated.

Unified communications may include the integration of real-time communication services (e.g., instant messaging) with non-real time communication services (e.g., SMS). Unified communications systems typically comprise not a single system but the integration of data from a potentially unlimited set of separate communications devices and systems.

As a further representative example, unified communications permits one party (e.g., a co-worker) to send a message on one medium and have it received by another party (e.g., another co-worker) on another medium. This process effectively transfers an activity from one communications medium to another. For example, a message recipient could receive an e-mail message from a co-worker and access it through a mobile phone. Unified communications has analogs in the home consumer market as well. A home user may want to watch a television program or surf the Internet uninterrupted, so long as an incoming message is from anyone other than a specific person.

As a representative for all forms of audio communications, unified communications certainly requires that audio output to be directed to the precise point where a user can derive the greatest benefit from the communications. In some circumstances, the misdirection of audio output may amount to more than just an inconvenience or a missed opportunity; such mistakes instead may have severe consequences for the user and his employer. Thus, a solution to the longstanding problem of misdirected communications is called for not only for general audio applications but especially for communications arising in a business context. A simple and robust solution for this problem is in order and highly desired by a frustrated community of users and business interests.

### SUMMARY OF THE INVENTION

Embodiments of the invention provide a system and method for routing sensory information in a communications system. These embodiments may comprise a peripheral device having a detector for providing a detector output indicating a peripheral device donned state or peripheral device doffed state. Embodiments of the invention also include a sensory control application, wherein the sensory control application enables sensory output at the peripheral device and/or at a host device that provides the sensory output, responsive to the detector output.

Embodiments of the invention provide a system and method for receiving sensory output on a peripheral device from a host device. These embodiments comprise determining if a peripheral device is in a donned state or doffed state. Embodiments of the invention also comprise enabling sensory output at the peripheral device or a host device associated with the peripheral device responsive to the peripheral device state.

### BRIEF DESCRIPTION OF THE DRAWINGS

FIG. 1 Illustrates a conventional prior art system 100 for controlling the flow of audio output/input between a headset 102 and a mobile phone 101;

FIG. 2 illustrates a system 200 that uses a Don/Doff sensor package 201 to control audio 203 on the mobile phone 101, according to an embodiment of the invention;

FIG. 3 illustrates two views of a headset 300 configured to include a capacitive Don/Doff sensor 303, according to an embodiment of the invention;

FIG. 4 illustrates a headset 400 having a Don/Doff sensor 401 and related logic 402, according to an embodiment of the invention;

FIG. 5 provides a flowchart 500 that shows the processing carried out by the logic 402 shown in FIG. 4, according to an embodiment of the invention;

FIG. 6 illustrates a headset 600 having a Don/Doff sensor 601 and an additional Don/Doff sensor 602, according to an embodiment of the invention;

FIG. 7 illustrates a dual speaker headset 700 that has been fitted with two Don/Doff sensors 701, 702, according to an embodiment of the invention;

FIG. 8 illustrates a system 800 that comprises a mobile phone 805 and a headset 801, according to an embodiment of the invention;

FIG. 9 illustrates a communications system 900 that includes a headset 901 and a mobile phone 903 having a proximity sensor 904, according to an embodiment of the invention;

FIG. 10 illustrates a system 1000 comprising a headset 1002 having a Don/Doff sensor 1008 and a mobile phone 1001 having a proximity sensor 1003, according to an embodiment of the invention;

FIG. 11 provides a flowchart 1100 that illustrates the processing performed by an audio application within a headset/mobile phone system to redirect audio output on a mobile phone (e.g., the application 1009 in the mobile phone 1001 in the system 1000 shown in FIG. 10), according to an embodiment of the invention;

FIGS. 12A and 12B illustrate a system 1200 that comprises a video output device 1201, a headset 1202, and enhanced glasses 1203, according to an embodiment of the invention; and

FIGS. 13A and 13B illustrate a system 1300 that uses a Don/Doff sensor 1303 to control graphic displays on enhanced eyeglasses 1301 that have been output from a video display device 1302, according to an embodiment of the invention.

FIGS. 14A and 14B illustrate systems 1400, 1450 that employ a Don/Doff sensor 1405 to control graphic displays on enhanced eyeglasses 1403, 1409 that have been output from a video display device 1401, according to an embodiment of the invention.

### DETAILED DESCRIPTION OF AN EMBODIMENT OF THE INVENTION

Embodiments of the invention provide a system and method for directing sensory outputs to peripheral devices based upon a user worn state (or Don/Doff state) as determined by a detector. Adjustments may be made dynamically without requiring user intervention, according to embodiments of the invention. Peripheral devices may comprise headsets, eyeglasses, and other devices configured to provide sensory outputs. Host devices may comprise mobile phones, personal computers, video display devices, and other devices that can be configured to output sensory data to peripheral devices. Sensory outputs from host devices may comprise audio, visual, audio/visual, and other sensory outputs capable of perception by a sentient being, such as sight, sound, touch, taste, and temperature. A sensory control application directs actions, such as the output of sensory data to a peripheral device, based upon the user Don/Doff state, according to an embodiment of the invention. A detector may comprise a device such as a Don/Doff sensor configured to detect a user worn state, according to an embodiment of the invention.

Embodiments of the invention provide a capability for determining if a user is wearing a headset (one example of a peripheral device) and then directing the flow of audio information to/from a handset device accordingly. In other words, if the user wears the headset, then audio data flows to the headset from the handset device; otherwise, the handset device outputs audio data from its organic speaker system, according to an embodiment of the invention. Embodiments of the invention employ a Don/Doff sensor in the headset to accomplish the task of determining if the user is wearing the headset.

Embodiments of the invention provide a capability for determining if a user is wearing eyeglasses (another example of a peripheral device) and then directing the flow of visual information to the eyeglasses accordingly. The eyeglasses may comprise, for example, glasses designed to aid the user in receiving a 3D video output. Thus, if the user wears the eyeglasses, then a video output device provides the user with a 3D video output, but if the user takes off the glasses, then the video output switches to something else, e.g., conventional 2D video output. Embodiments of the invention employ a Don/Doff sensor in the eyeglasses to accomplish the task of determining if the user is wearing the eyeglasses.

All headsets have speakers, and the ability to determine whether a headset is currently being worn (“donned”) or not worn (“doffed” or “undonned”) on the ear of a user is useful in a variety of contexts. For example, whether a user's headset is donned or doffed may indicate the user's ability or willingness to communicate, often referred to as user “presence.” User presence is increasingly important in unified communications (UC) as the methods, devices, and networks by which people may communicate, at any given time or location, proliferate. The determination of whether a user's headset is donned or doffed is also useful in a variety of other contexts in addition to presence.

FIG. 2 illustrates a system 200 that uses a Don/Doff sensor package 201 to control audio 203 on the mobile phone 101, according to an embodiment of the invention.

The sensor package 201, which comprises an example of a sensory control application, detects when a user has placed a headset 202 on his head (a Donned state) or removed the headset 202 from his head (a Doffed state). The sensor package 201 adjusts the audio 203 to the headset 202, accordingly, using conventional communications 106, 107 to the mobile phone 101. The audio 203 comprises a speaker and related electronics and equipment.

For example, if sensor package 201 detects a user Donned state and the headset 202 and the mobile phone 101 have existing communications 106, 107, then the sensor package 201 does not interrupt the communications 106, 107. On the other hand, if the sensor package 201 detects a user Doffed state and the headset 202 and the mobile phone 101 have existing communications 106, 107, then the sensor package 201 interrupts the communications 106, 107 using conventional commands that cause conventional functionality on the mobile phone 101 to direct audio output to the mobile phone's organic speaker system (e.g., the sensor package 201 terminates a Bluetooth connection between the headset 202 and the mobile phone 101) rather than to the audio 203. Thus, the sensor package 201 controls the audio 203 on the headset 202 based upon the user's Donned/Doffed state.

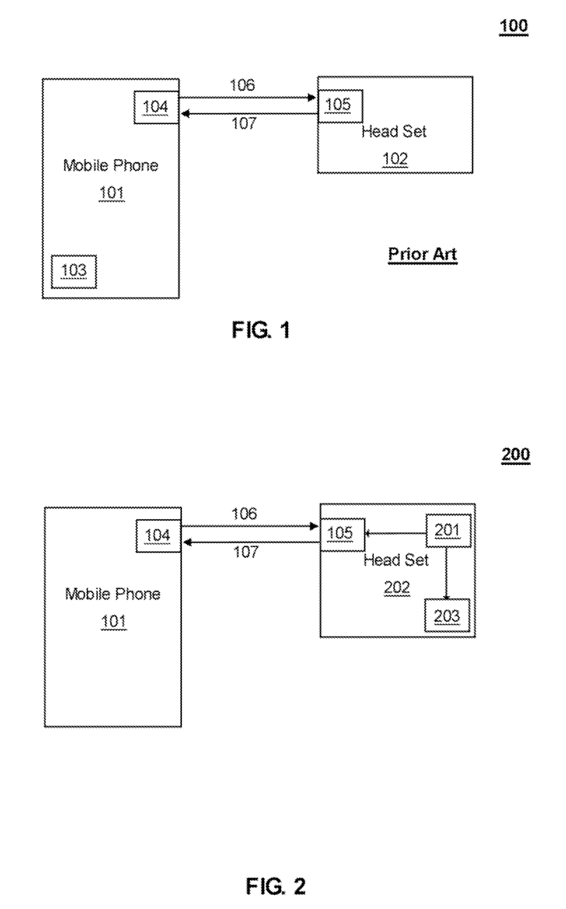

In some embodiments of the invention, the mobile phone 101 requires no adjustments or additional capabilities beyond the conventional design shown in FIG. 1. Thus, only the headset 202 requires modifications beyond the conventional design in such embodiments. The headset's modifications comprise the addition of the sensor package 201, which comprises a Don/Doff sensor and related logic, according to an embodiment of the invention.

Audio may be directed to/from the headset 202 automatically based upon the Don/Doff status detected by the sensor package 201, as discussed above. Alternatively, the headset 202 and/or the mobile phone 101 may have a capability for user control that could either enable or disable the automatic direction of audio output based upon the detection of the sensor package 201. In yet other embodiments, the headset 202 and/or the mobile phone 101 may have a capability to supplement and/or enhance the processing of data related to the sensor package 201. For example, the headset 202 might have a user-selectable configuration in which audio output continues to be directed to the headset 202 when the sensor package 201 detects a Doffed state but the volume of the audio 203 increases to some higher level, e.g., a higher level than would typically be comfortable for most users in a Donned state but high enough that the typical user could still hear the output while deciding whether to switch to the handset 101 or don the headset 202.

In an alternative embodiment of the invention, the mobile phone 101 may be configured to control the flow of audio information to the headset 202. In such an embodiment, the sensor package 201 sends the detected Donned/Doffed state to the mobile phone 101 and logic functions on the mobile phone 101 determine the mobile phone's behavior (e.g., the direction of audio output).

In such an embodiment, the transceiver 105 relays the Don/Doff state information to the transceiver 104 on the mobile phone 101 (e.g., the Donned state that the headset 202 is being worn by the user and should receive the output of any audio generated by or through the mobile phone 101), according to an embodiment of the invention. Similarly, the sensor package 201 also detects when a user has removed, or doffed, the headset 202 from his head. The sensor package 201 directs the reporting of this information to the transceiver 105 on the headset 202. The transceiver 105 reports to the transceiver 104 on the mobile phone 101 that the headset 202 is no longer worn by the user and that the headset 202 should no longer receive the output of any audio generated by or through the mobile phone 101, according to an embodiment of the invention.

The system 200 shown in FIG. 2 represents a wireless embodiment of the invention. In an alternative embodiment, the system 200 may use a wired connection between the mobile phone 101 and the headset 202 with the communications 106, 107 running through the wire that connects the mobile phone 101 and the headset 202, according to an embodiment of the invention.

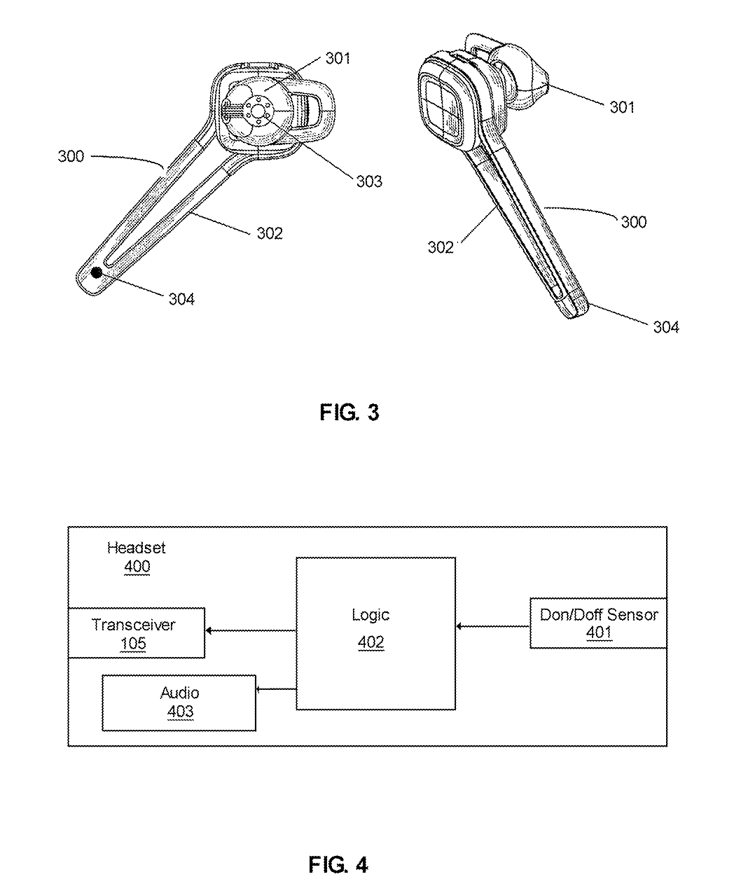

FIG. 3 illustrates two views of a headset 300 configured to include a capacitive Don/Doff sensor 303, according to an embodiment of the invention. While sensing proximity to a user's head can be done in various places on a headset, one location that strongly indicates the headset 300 is being worn is the headset region that goes near the ear opening or into the ear. The speaker in most headsets is typically close to the ear opening, the optimum region for sensing that the headset is worn.

The headset 300, which includes the Don/Doff sensor 303, also comprises a body 302, a microphone 304, and an optional earpiece 301 covering a portion of the sensor 303, according to an embodiment of the invention. Optional earpiece 301 may, for example, be composed of a soft flexible material such as rubber to conform to the user's ear when the headset 300 is donned. The components of the headset 300 are of conventional design and need not be discussed in detail. The headset 300 includes a system which determines whether the Don/Doff sensor 303 is touching or within close proximity or adjacent to the user ear. Thus, the headset 300 provides a capacitive touch sensing system, according to an embodiment of the invention.

In donning the headset 300, the user typically inserts the sensor 303 into the concha of the ear, and the sensor 303 typically fits snugly in the concha so that the headset 300 is supported by the user's ear, according to an embodiment of the invention. The sensor 303 may be formed in part of an electrically conductive material. The electrically conductive element of the sensor 303 may either contact the user's ear or be sufficiently close to the user's ear to permit detection of capacitance in some embodiments of the invention that employ capacitance sensing. The sensor 303 may comprise an electrode while the user's ear may be considered the opposing plate of a capacitor with the capacitance Ce. A touch sensing system is electrically connected to the electrode, and the touch sensing system determines whether the electrode is touching or in close proximity to the user's ear based on the capacitance Ce when the electrode is touching or close to the ear and when the electrode is not. When the electrode is touching or in close proximity to the skin of the user's ear, an increase in relative capacitance may be detected.

The touch sensing system can be located in an apparatus such as a printed circuit board (PCB), according to an embodiment of the invention, and there is parasitic capacitance between the electrode and the PCB ground plane which may be illustrated as Cp. The capacitance between the user's ear and the electrode is indicated as Ce, and Cu indicates the capacitance between the PCB ground plane and the user. Assuming that Cp is negligible or calibrated for, the total capacitance seen by the touch sensing system is the series capacitance of the electrode to the ear, Ce, and the head to the system, Cu. The capacitive connection of the user to the system ground Cu is often a factor of 10 or more than the capacitance of the ear to the electrode Ce, so that the Ce dominates, according to an embodiment of the invention.

Use of capacitive touch sensing systems is further discussed in the commonly assigned and co-pending U.S. patent application Ser. No. 12/501,961 entitled “Speaker Capacitive Sensor” (Attorney Docket No.: 01-7563), which was filed on Jul. 13, 2009 and U.S. patent application Ser. No. 12/060,031 entitled “User Authentication System and Method” (Attorney Docket No.: 01-7437), which was filed on Mar. 31, 2008, and both of which are hereby incorporated into this disclosure in its entirety by reference.

FIG. 4 illustrates a headset 400 having a Don/Doff sensor 401 and related logic 402, according to an embodiment of the invention. As previously discussed, the sensor package 201 shown in FIG. 2, for example, comprises a Don/Doff sensor, such as the Don/Doff sensor 401, and related logic, such as the logic 402. The logic 402 comprises an example of a sensory control application, according to an embodiment of the invention. The logic 402 comprises a small system configured for processing information received from the sensor 401 and for controlling audio 403 (e.g., turning audio on/off based on a Donned or Doffed state of the headset 400). In some embodiments, the logic 402 may also provide output that can be sent over the transceiver 105 to a mobile phone.

The logic 402 may comprise a small electronic circuit and/or a small amount of computer code adapted for operation on a processor. The logic 402 may be configured to perform additional tasks beyond those discussed here. As discussed above, a Don/Doff sensor may include some logic of its own to help it determine when a user is wearing the headset 400. This logic may be included in the logic 402. Alternatively, the logic 402 may be incorporated into a more comprehensive logic device associated with other functions performed by the headset 400, according to an embodiment of the invention.

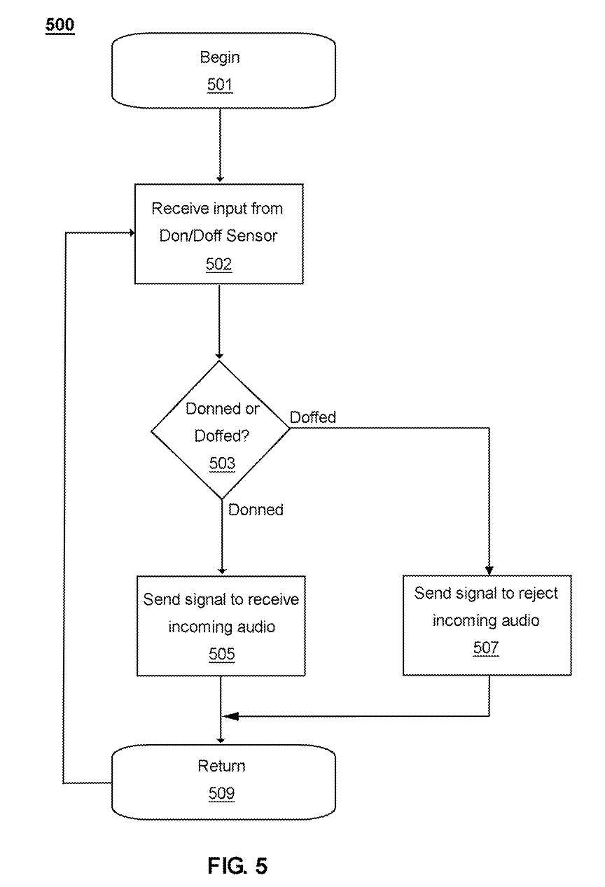

FIG. 5 provides a flowchart 500 that shows processing carried out by the logic 402 shown in FIG. 4, according to an embodiment of the invention. As previously mentioned, the logic 402 comprises an example of a sensory control application. The logic 402 receives (step 502) input from the headset's Don/Doff sensor that indicates the headset's Don/Doff state (e.g., the Don/Doff sensor 301 shown in FIG. 3). The Don/Doff sensors may be configured to communicate their state continuously or only when their state changes. The logic 402 primarily concerns itself with state changes, according to an embodiment of the invention.

The logic 402 determines whether the Don/Doff sensor's output indicates a donned or doffed state (step 503). If the logic determines a donned state (step 503), then the logic 402 sends a signal to receive incoming audio on the headset (step 505). The logic 402 may typically be instructed to send the signal to an appropriate component on an associated mobile phone, according to an embodiment of the invention. The signal may be sent via a transceiver (e.g., the transceiver 105 shown in FIG. 2) to a transceiver (e.g., the transceiver 104 shown in FIG. 2) on the associated mobile phone. The signal may be formatted and configured for transmission according to a conventional protocol (e.g., Bluetooth) used for communications between the headset and the mobile phone.

If the logic 402 determines that the Don/Doff sensor's output indicates a doffed state (step 503), then the logic 402 sends a signal instructing (step 507) the rejection of incoming audio on the headset. The logic 402 may typically be instructed to send the signal to an appropriate component on an associated mobile phone, according to an embodiment of the invention. The signal may be sent via a transceiver (e.g., the transceiver 105 shown in FIG. 2) to a transceiver (e.g., the transceiver 104 shown in FIG. 2) on the associated mobile phone. The signal may be formatted and configured for transmission according to a conventional protocol (e.g., Bluetooth) used for communications between the headset and the mobile phone.

After processing a received signal from the Don/Doff sensor, the logic 402 returns (step 509) to a state (step 502) of waiting for another signal from the Don/Doff sensor. The processing provided by the logic 402 typically continues indefinitely, so long as the headset has an operable power supply and is turned on.

Embodiments of the invention may employ nearly any kind of Don/Doff sensor. In alternative embodiments of the invention, the Don/Doff sensor operates by means other than a capacitive sensor. Alternative sensors that could be applied include temperature sensing devices, mechanical devices, mercury switch device, and optical switches. Embodiments of the invention may employ Don/Doff sensors regardless of their fundamental operating principles so long as the sensors provide an indication of Don/Doff state. Similarly, embodiments of the invention may employ multiple Don/Doff sensors.

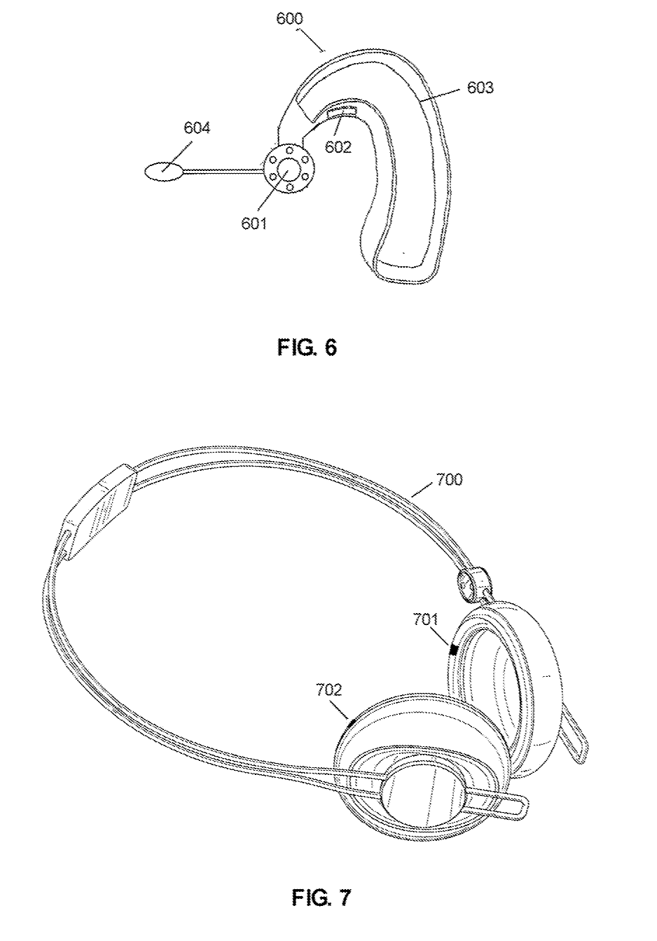

FIG. 6 illustrates a headset 600 having a Don/Doff sensor 601 and an additional Don/Doff sensor 602, according to an embodiment of the invention. The sensor 602 is disposed on the headset 600 at a location away from a sensor 601, such as a location along the headset housing 603. Sensors 601, 602 may be capacitive type sensors or other types of sensor. The control mechanism for these sensors (e.g., a mechanism similar to the logic 402 shown in FIG. 4) may be configured to operate in a variety of ways to fit the needs of particular target users. For example, the logic (e.g., the logic 402) may require both Don/Doff sensors to be engaged before audio is automatically routed to the headset 600. Alternatively, the logic may automatically route audio to the headset 600 based on a positive indication of a donned state from just one of the sensors 601, 602.

FIG. 7 illustrates a dual speaker headset 700 that has been fitted with two Don/Doff sensors 701, 702, according to an embodiment of the invention. The control mechanism for these sensors (e.g., a mechanism similar to the logic 402 shown in FIG. 4) may be configured to operate in a variety of ways to fit the needs of particular target users. For example, the logic may require both Don/Doff sensors to be engaged before audio is automatically routed to the headset 700. Alternatively, the logic may automatically route audio to the headset 700 based on a positive indication of a donned state from just one of the sensors 701, 702.

Embodiments of the invention may be employed to solve problems other than just directing audio output to an appropriate device/speaker in a mobile phone application. The same principles, for example, can be employed to switch the speakers on a personal computer (PC) when the user has donned/doffed a headset. Embodiments of the invention may be applied to detecting when content on various smartphone applications should change.

The facility (e.g., application, circuit, etc.) that controls the flow of audio output (e.g., the logic 402) could be located on the mobile phone as well as, or in addition to being located on the headset. In many mobile phone models, the mobile phone can sense when it has been brought up to the user's head. For example, models of the Apple iPhone can sense that it has been brought to the user's head. Many of these advanced mobile phones employ optical sensors to detect when they have been brought to the user's head. The precise implementation of the mobile phone sensing apparatus is not relevant here, so long as the sensing apparatus can make its status known. Embodiments of the invention may employ the status information from mobile phones to alter the direction and/or quality of audio output to a headset. Some of these embodiments may be employed in headsets that themselves do not have Don/Doff sensors.

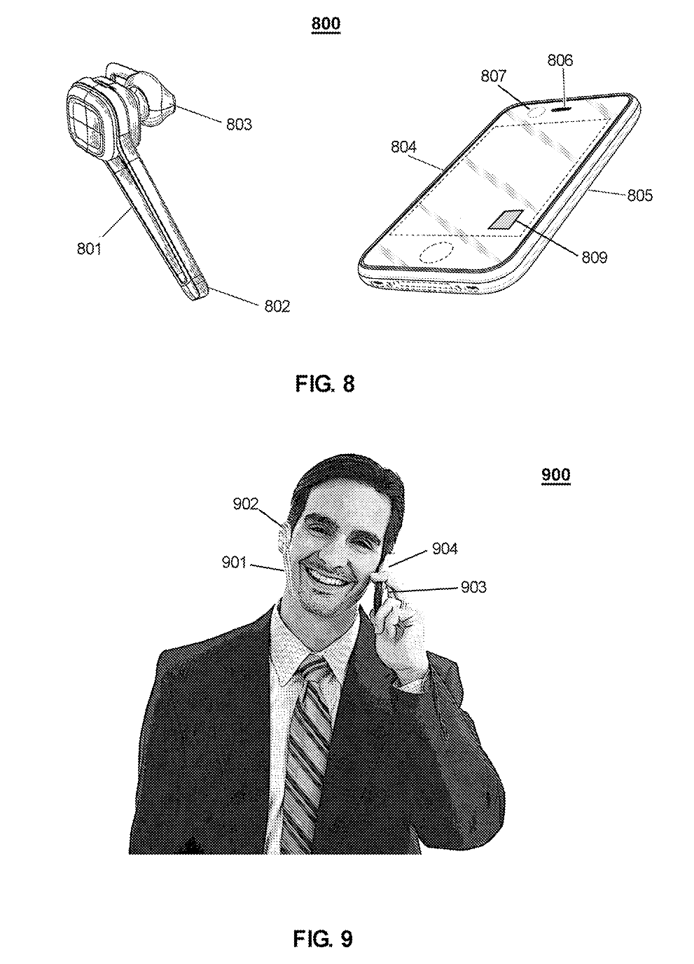

FIG. 8 illustrates a communication system 800 that comprises a mobile phone 805 and a headset 801, according to an embodiment of the invention. The mobile phone 805 includes a proximity sensor 807 that can detect when the phone has been brought to the user's head. The mobile phone 805 also includes a speaker 806 and a display 804. The headset 801 includes a Don/Doff sensor 803 and a speaker 802.

Assume that headset 801 has a communication link with the mobile phone 805. When user brings the mobile phone 805 up to his head, then an application 809 on the mobile phone 805 senses this change in status and alters the direction of audio output sent to the headset 801. The application 809 comprises an example of a sensory control application. The alteration in the audio output could be in the form of turning off the audio output altogether on the headset 801 so long as the mobile phone 805 is held to the user's head, or alternatively, the alteration could be in the form of adjusting an audio characteristic such as the volume level of the audio output on the headset 801.

The mobile phone 805 combined with the proximity sensor 807 can also be employed with headsets that do not include Don/Doff sensors such as the sensor 803. Assume, for example, that a user has connected his headset to the mobile phone 805 but has later removed the headset from his ear. As discussed above, in conventional applications, the audio output will continue to flow to the headset unless the user takes an affirmative step to alter the flow. Using the mobile phone 805 with the proximity sensor 807, then all the user needs to do to alter the flow of audio information to the headset is lift the mobile phone 805 to his head.

FIG. 9 illustrates a communications system 900 that includes a headset 901 and a mobile phone 903 having a proximity sensor 904, according to an embodiment of the invention. The proximity sensor 904 is capable of detecting when the user has brought the mobile phone 903 to his head.

When the user brings the mobile phone 903 to his head, then the audio output to the headset 901 changes. In various embodiments of the invention, the change to the audio output may take the form of a complete termination of audio output so long as the mobile phone 903 is held to the user's head, as determined by the sensor 904, or alternatively may take another form such as diminished audio output.

The headset 901 shown in FIG. 9 includes a Don/Doff sensor 902. Thus, in the system 900 the additional information from the mobile phone sensor 904 supplements the ability to control the direction of audio information in a manner consistent with the embodiments of the invention already discussed. However, as discussed above, the headset 901 need not necessarily include the Don/Doff sensor 902. In such embodiments, the sensor 904 plays a role similar to that of the Don/Doff sensor 201 shown in FIG. 2.

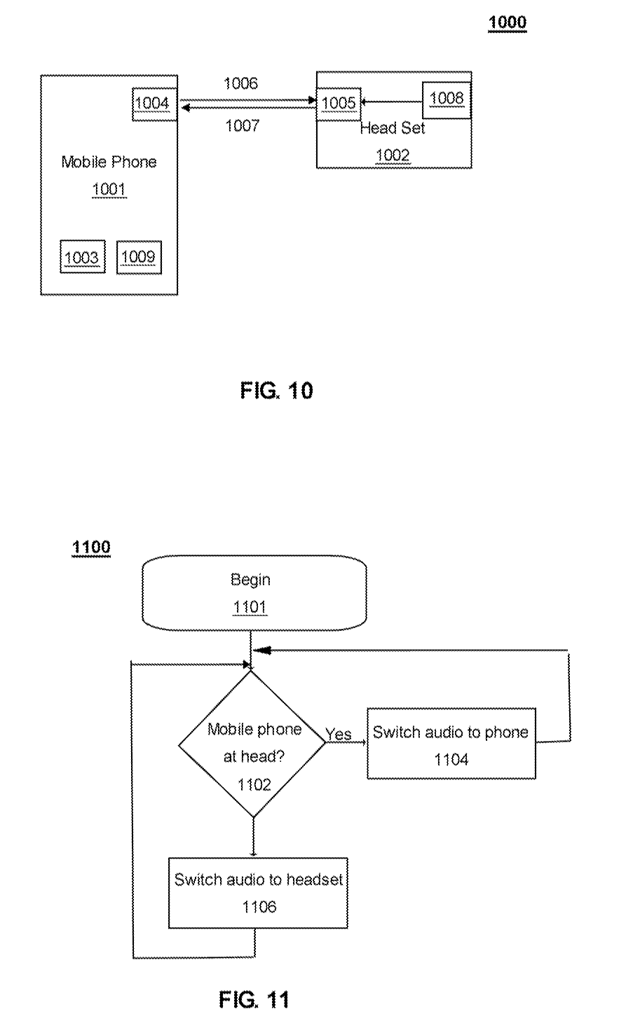

FIG. 10 illustrates a system 1000 comprising a headset 1002 having a Don/Doff sensor package 1008 and a mobile phone 1001 having a proximity sensor 1003, according to an embodiment of the invention. The Don/Doff sensor package 1008 comprises an example of a sensory control application.

The headset 1002 applies the Don/Doff sensor package 1008 in a manner consistent with the Don/Doff sensor package 201 shown in FIG. 2. When the Don/Doff sensor package 1008 determines that the user has donned the headset 1002, then the Don/Doff sensor package 1008 communicates a change in audio output direction (e.g., that audio should be sent to the headset 1002) via transceiver 1005 to transceiver 1004 on the mobile phone 1001 and audio output subsequently goes to the headset 1002.

When the proximity sensor 1003 determines that the mobile phone 1001 has been moved to the user's head, then the sensor 1003 may cause the mobile phone 1001 to alter how it presents/provides audio data to the headset 1002. The transceiver 1004 may also signal the transceiver 1005 to instruct the sensor package 1008 that the mobile phone's status has changed.

The proximity sensor 1003 may operate in conjunction with a small application 1009 (known as an “app”) that can communicate the proximity state of the mobile phone 1001. The application 1009 also comprises an example of a sensory control application. The application 1009 typically resides at the programming layer on the mobile phone 1001, according to an embodiment of the invention. Many mobile phones publish their APIs so the necessary status information may be relatively easy to obtain. In addition, some mobile phone operating systems, such as Android, are open source and the code is typically available in adherence with open source policies and requirements. Of course, some phones do not necessarily publish access to the audio switching and phone-to-ear sensing functionality although they have built-in applications. The API for the iPhone is “BOOL proximityState,” and, for example, there is a similar call for the Android. While this approach is technically feasible, in some situations the developer may experience difficulty in finding the pertinent technical information for a given phone without receiving assistance from the phone's manufacturer. For other systems, the information may be mixed. For example, the iPhone and Android both provide proximity information (e.g., that the user has activated the proximity sensor such as the sensor 1003), but these particular phone manufacturers do not presently provide public disclosure of their audio switching APIs.

The application 1009 typically comprises a small computer program that uses the organic processing power (e.g., a small computer) on the mobile phone 1001 to process proximity sensor information from the proximity sensor 1003. The application 1009 could be alternatively performed with a specialized circuit and/or other techniques for performing an equivalent function known to artisans in the field.

FIG. 11 provides a flowchart 1100 that illustrates the processing performed by an audio application within a headset/mobile phone system to redirect audio output on a mobile phone (e.g., the application 1009 in the mobile phone 1001 in the system 1000 shown in FIG. 10), according to an embodiment of the invention. The flowchart 1100 is applicable both to systems in which the headset includes a Don/Doff sensor and to systems in which the headset does not include a Don/Doff sensor.

A sensor, such as the proximity sensor 1003 shown in FIG. 10, on the mobile phone monitors the position of the mobile phone and provides its output to the audio application (step 1102). If the proximity sensor communicates to the audio application that the mobile phone is at the user's head (step 1102), then the audio application instructs the mobile phone to switch the audio to the phone's organic audio output system rather than through the headset (step 1104). Once this change has been made, then the audio application returns to monitoring for a change in the phone's proximity status (step 1102).

As previously discussed in some alternative embodiments, the application on the mobile phone may engage various alternative behaviors such as diminishing the audio output of the headset rather than a complete redirection of audio output from the mobile phone. Among other things, in some configurations, this approach could provide the user with a stereo-like quality audio for those situations where a user had a headset in one ear and the mobile phone held to the opposite ear.

If the sensor determines that the mobile phone is not at the user's head and communicates this status change to the audio application (step 1002), and a headset has been connected to the mobile phone, then the audio application switches audio from the mobile phone to the headset (step 1106). Once this change has been made, then the audio application returns to monitoring for a change in the phone's status (step 1102).

In an alternative embodiment of the invention, including embodiments where no headset is present, the audio application could switch audio output to the mobile phone's speaker phone function in step 1106, provided that the mobile phone had speaker phones available to it.

Processing in the flowchart 1100 continues so long as the mobile phone is switched on and the mobile phone remains connected to a headset.

As discussed above, both sensors on the headset and the mobile phone could be used, according to an embodiment of the invention. If the headset is worn, but the mobile phone is not near the head, then the audio is routed to the headset. If the mobile phone is brought to the ear (“exclusive or” or “inclusive or” with respect to headset Donned state), then audio comes out the mobile phone's ear speaker. If neither is the case, the audio comes out the speakerphone function of the mobile phone, according to an embodiment of the invention.

The proximity information provided by mobile phones, such as the mobile phone 1001 shown in FIG. 10, can be used with other headset-like devices. For example, the mobile phone proximity switching can be used to turn off and/or adjust the audio on a hearing aid when the mobile phone and/or telephone handset is brought near the user's ear and/or when the user is wearing a headset.

The audio level for a hearing aid is not always optimum for listening with a headset or a mobile phone. This is another embodiment that could employ audio switching based on Don/Doff of the headset and head proximity of the mobile phone. When a headset is donned, the hearing aid audio could be adjusted and/or switched off. When the mobile phone senses that it is against the user's head, the mobile phone could turn on a magnetic or AC field that is sensed by the hearing aid that causes the hearing aid to cuts and/or adjusts its audio.

Embodiments of the invention may also be employed to direct more than just audio output. For example, embodiments of the invention may also be applied to the applications related to aspects of video output as well. Embodiments of the invention may also provide an ability for switching audio and video between two-dimensional and three dimensional applications, such as by sensing when a user has donned/doffed the equipment for receiving a three-dimensional video output.

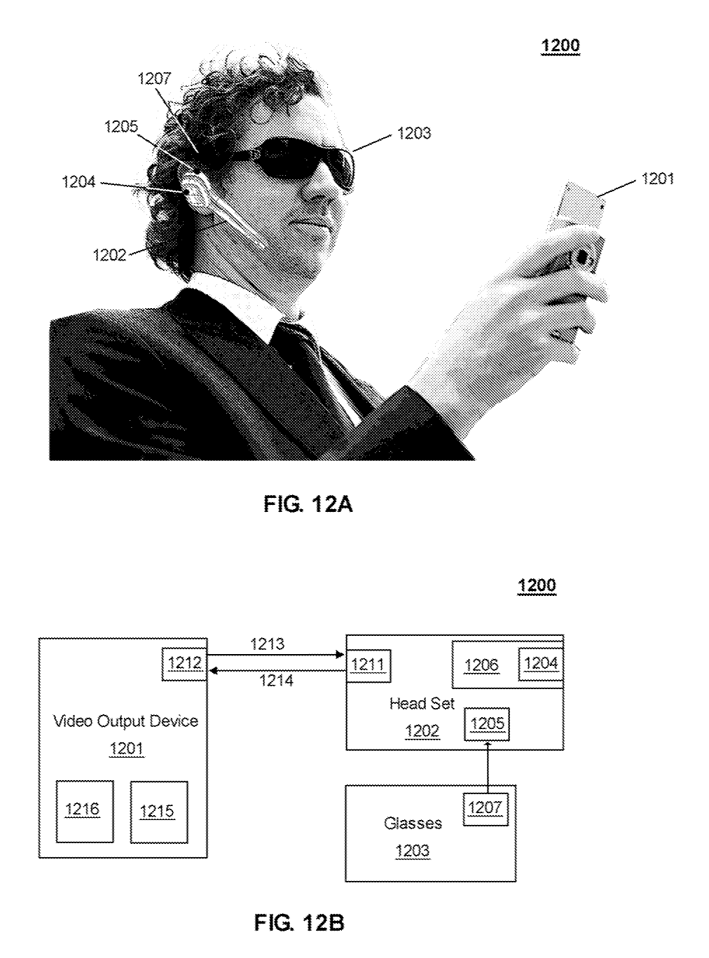

FIGS. 12A and 12B illustrate a system 1200 that comprises a video output device 1201, a headset 1202, and enhanced glasses 1203, according to an embodiment of the invention. The enhanced glasses 1203 work with an application 1215 provided by the video output device 1201. The enhancement provided by the enhanced glasses 1203 could range from a three-dimensional viewing of content on the video output device 1201 to an enhanced reality application on the video output device 1201 that provides additional content to the user, such as an overlay over the real world viewed through the glasses 1203 as enhanced by additional content provided by equipment such as a global positioning system indicator associated with the video output device 1201. The video output device 1201 could comprise devices such as a mobile phone, a camera, a video recorder, a 3D still or video output device, or another similar type of device. The headset 1202 includes a capability for communicating 1213, 1214 with the video output device 1201, such as via a Bluetooth connection.

The video output device 1201 becomes aware that the user has donned the enhanced glasses 1203 via a sensor 1207 provided in the enhanced glasses 1203 and a related sensor 1205 provided in the headset 1201, according to an embodiment of the invention. The sensor pair 1205-1207 could comprise a variety of types. For example, the sensor pair 1205-1207 could employ capacitive coupling or inductive coupling, according to an embodiment of the invention. The sensor 1207 could include a passive RFID tag and the sensor 1205 could employ an RFID reader that inductively senses the presence of the sensor 1207, which would indicate a Donned state for the enhanced glasses 1203. The sensor pair 1205-1207 could alternatively comprise a touch sensor such as a Don/Doff sensor where the material sensed could be a metal plate in the glasses 1203, according to an embodiment of the invention. Alternatively, the sensor pair 1205-1207 could comprise a reed relay using a magnet in the sensor 1207 whose presence was detected by the sensor 1205. In some embodiments, the use of a reed relay would require that the glasses 1203 physically touch the headset 1202 in order for the sensor pair 1205-1207 to work properly.

Regardless of how the sensor pair 1205-1207 operates, once the sensor 1205 becomes aware of the presence of the sensor 1207, then the sensor 1205 can signal to the video output device 1201 that the user is wearing the enhanced glasses 1203, and the video output device 1201 can begin providing the alternative content that would be suggested by the presence of the enhanced glasses 1203. The sensor 1207 could be embedded and/or attached to the enhanced glasses 1203 at relatively low cost, and the enhanced glasses 1203 would not necessarily need to have any other electronic appliances in order for the Don/Doff state of the glasses 1203 to be signaled to the video output device 1201. Of course, if the nature of the enhanced glasses 1203 was such that the glasses 1203 included an electronic connection to the video output device 1201, then the sensor 1207 could itself be configured to communicate directly to the video output device 1201.

FIG. 12B provides a block diagram of the system 1200 in which the enhanced glasses 1203 communicate to the headset 1202, which in turn communicates to the video output device 1201, according to an embodiment of the invention.

The sensor 1207 communicates its presence to a sensor 1205 on the headset 1202. The sensor 1205 communicates any changes in its status to a transceiver 1211 that in turn communicates to a transceiver 1212 via a connection 1214. For communications related to the sensor 1205, the transceiver 1212 can forward the sensor data to an enhanced glasses application 1215 on the video output device 1201. The enhanced glasses application 1215 could provide functionality from applications ranging from a 3D viewer to an enhanced reality application. The application 1215 could cause changes to be made to how a display on the video output device 1201 appears to changes in data being transmitted to the enhanced glasses 1203, according to various embodiments of the invention. The application 1215 comprises an example of a sensory control application.

A Don/Doff sensor package 1206 comprises logic and a Don/Doff sensor 1204, and the Don/Doff sensor package 1206 controls audio on the headset 1202, according to an embodiment of the invention. The Don/Doff sensor package 1206 operates in a manner similar to the Don/Doff sensors discussed herein in conjunction with audio applications on headsets. The Don/Doff sensor package 1206 comprises an example of a sensory control application.

The Don/Doff sensor package 1206 may also signal changes in its status (e.g., don or doff) to the transceiver 1211 that communicates these changes to the transceiver 1212 on the video output device 1201. The transceiver 1212 transmits data from the sensor package 1206 to an audio application 1216 in a manner similar to that previously discussed herein, according to an embodiment of the invention. The application 1216 also comprises an example of a sensory control application.

The applications 1216 and 1215 may coordinate with each other regarding information displays and audio information. For example, if the sensor package 1206 indicates that the headset 1202 is in a donned status but the sensor 1205 indicates that the glasses 1203 are not in a donned state, then the applications 1216, 1215 may make different decisions regarding the transmissions for audio/visual data than these applications 1216, 1215 would make in other circumstances. Table 1 below provides a chart showing the possible states for the headset 1202 and the glasses 1203:

TABLE 1

| | |
|---|---|
| Item | Glasses |

| | | |
|---|---|---|
| Headset | Donned/Donned | Donned/Doffed |
| | Doffed/Donned | Doffed/Doffed |

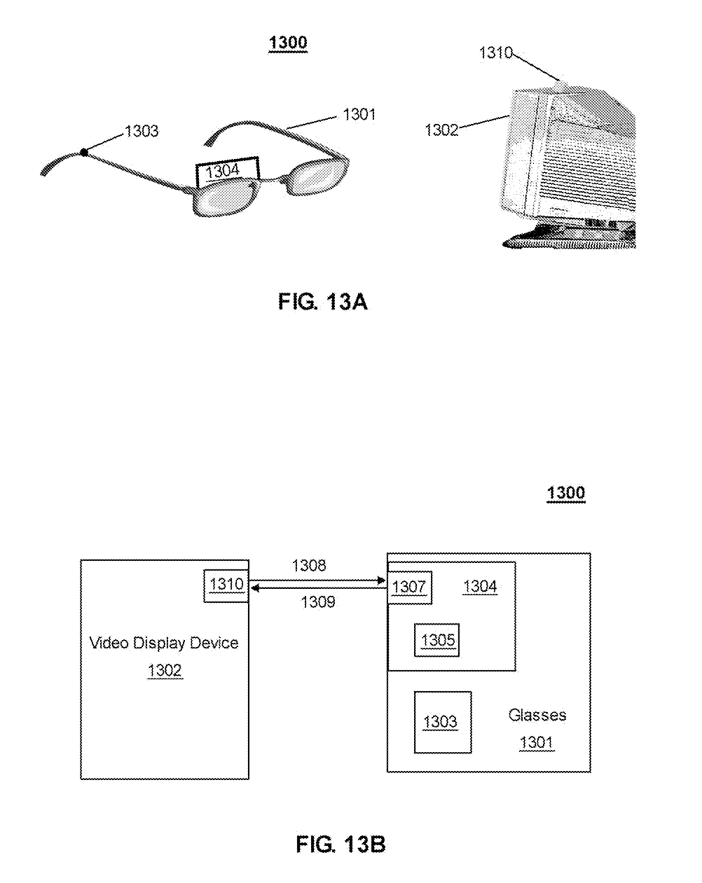

FIGS. 13A and 13B illustrate a system 1300 that uses a Don/Doff sensor 1303 to control graphic displays on enhanced eyeglasses 1301 that have been output from a video display device 1302, according to an embodiment of the invention. The video display device 1302 could comprise devices such as a mobile phone, a camera, a video recorder, a 3D still image display device, a 3D video display device, or another similar type of display device. The enhanced glasses 1301 include a capability for communicating 1308, 1309 with the video display device 1302, such as via a Bluetooth connection.

The sensor 1303 detects when a user has placed the enhanced glasses 1301 on his head (a Donned state) or removed the enhanced glasses 1301 from his head (a Doffed state). The sensor 1303 may comprise a capacitive sensor, for example. A sensor package 1304 adjusts the video to the enhanced glasses 1301, accordingly. The sensor package 1304 comprises an example of a sensory control application.

For example, if sensor 1303 detects a user Donned state, then the sensor package 1304 arranges a video display from the video display device 1302 and makes whatever adjustments are needed on the eyeglasses 1301, according to an embodiment of the invention. On the other hand, if the sensor 1303 detects a user Doffed state and the enhanced glasses 1301 and the video display device 1302 have existing connection, then the sensor package 1304 interrupts the connection with the video display device 1302 such that the video display device 1302 directs video output in a different manner (e.g., the video display device 1302 depicts the video on its own display in 2D). Thus, the sensor package 1304 controls the output on the enhanced glasses 1301 based upon the user's Donned/Doffed state.

In some embodiments of the invention, the video display device 1302 requires no adjustments or additional capabilities beyond the conventional design. Thus, only the enhanced glasses 1301 require modifications beyond the conventional design in such embodiments.

The enhanced glasses' modifications comprise the addition of the sensor 1303, and the sensor package 1304, according to an embodiment of the invention. As shown in FIG. 13B, the sensor package 1304 comprises a transceiver 1307 and a sensor logic 1305. The sensor logic 1305 processes data from the Don/Doff sensor 1303 in a manner similar to the logic 402 shown in FIG. 4 for audio data, according to an embodiment of the invention. In some embodiments of the invention, the glasses 1301 may comprise additional capabilities for adjusting glasses parameters themselves (e.g., fine-tuning the user's viewing experience).

Video display may be directed to the enhanced glasses 1301 automatically based upon the Don/Doff status detected by the sensor 1303, as discussed above. Alternatively, the enhanced glasses 1301 and/or the video display device 1302 may have a capability for user control that could either enable or disable the automatic direction of video output based upon the detection of the sensor 1303. In yet other embodiments, the enhanced glasses 1301 and/or the video display device 1302 may have a capability to supplement and/or enhance the processing of data related to the sensor 1303. For example, the enhanced glasses 1301 might have a user-selectable configuration in which video output continues to be directed to the enhanced glasses 1301 when the sensor 1303 detects a Doffed state but a characteristic of the output video changes.

In an alternative embodiment of the invention, the video display device 1302 may be configured to control the flow of video information to the enhanced glasses 1301. In such an embodiment, the sensor 1303 sends the detected Donned/Doffed state to the video display device 1302 and logic functions on the video display device 1302 determine the device's behavior (e.g., the direction of video output). In essence, the sensor logic 1305 is located on the video display device 1302 in such embodiments.

In such an embodiment, the transceiver 1307 relays the Don/Doff state information to the transceiver 1310 on the video display device 1302 (e.g., the Donned state that the enhanced glasses 1301 is being worn by the user and should receive the output of any video generated by or through the video display device 1302), according to an embodiment of the invention. Similarly, the sensor 1303 also detects when a user has removed, or doffed, the enhanced glasses 1301 from his head. The sensor package 1304 directs the reporting of this information to the transceiver 1307 on the enhanced glasses 1301. The transceiver 1307 reports to the transceiver 1310 on the video display device 1302 that the enhanced glasses 1301 are no longer worn by the user and that the enhanced glasses 1301 are no longer providing the user with the output of the video display device 1302.

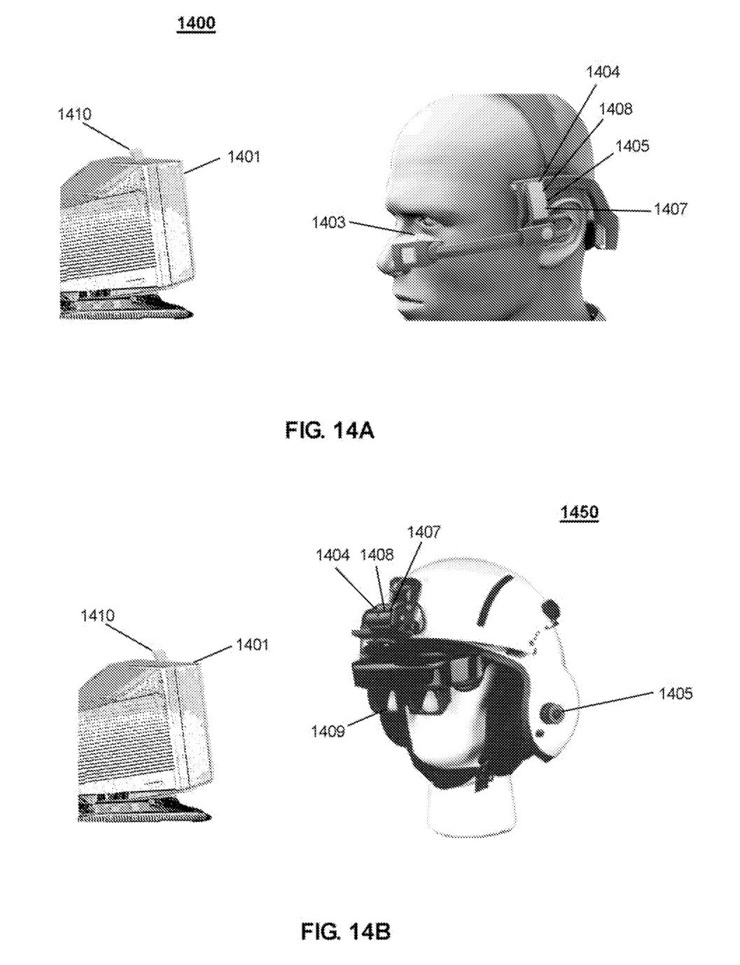

FIGS. 14A and 14B illustrate systems 1400, 1450 that employ a Don/Doff sensor 1405 to control graphic displays on enhanced eyeglasses 1403, 1409 that have been output from a video display device 1401, according to an embodiment of the invention. Enhanced glasses 1403 represent a single eye screen heads-up display device and enhanced glasses 1409 represent a dual eye screen heads-up display device. The video display device 1401 could comprise devices such as a mobile phone, a camera, a video recorder, a 3D still image display device, a 3D video display device, a graphical instrument panel, or another similar type of display device.

The enhanced glasses 1403, 1409 may be configured to provide the same content as that provided by the video display 1401 and/or configured to superimpose additional data upon what the wearer sees through the glasses in a manner conventionally provided by heads-up display devices. The enhanced glasses 1403, 1409 include a capability for communicating with the video display device 1401, such as via a Bluetooth connection. The connection between the enhanced glasses 1403, 1409 may be wired or wireless in various embodiments of the invention.

The sensor 1405 detects when a user has placed the enhanced glasses 1403, 1409 on his head (a Donned state) or removed the enhanced glasses 1403, 1409 from his head (a Doffed state). The sensor 1405 may comprise a capacitive sensor, for example.

A sensor package 1404 adjusts the video to the enhanced glasses 1403, 1409, accordingly. The sensor package 1404 operates in a manner similar to that of the sensor package 1304 shown in FIG. 13B. The sensor package 1404 comprises an example of a sensory control application.

The sensor package 1404 may include an additional capability for switching video from a display device like a computer screen, such as that provided by the video display device 1401, and providing the video for a single eye screen such as that provided by the enhanced glasses 1403 or providing the video for a dual eye screen such as that provided by the enhanced glasses 1409. Thus, the video data provided to the user of enhanced glasses 1403, 1409 in a donned state may have different properties and content than the video data provided to the user from the video display device 1401 when the enhanced glasses 1403, 1409 are in the doffed state, according to an embodiment of the invention.

These differing video characteristics, however, may represent the conventional views provided by heads-up displays in comparison to that provided by screen-like display devices, albeit switched from one video type to another in accordance with the state of the sensor 1405, according to an embodiment of the invention. For example, if the sensor 1405 detects a user Donned state, then the sensor package 1404 arranges a video display from the video display device 1401 and makes whatever adjustments are needed on the eyeglasses 1403, 1409 to make the display suitable for a heads-up display, according to an embodiment of the invention. On the other hand, if the sensor 1405 detects a user Doffed state and the enhanced glasses 1403, 1409 and the video display device 1401 have existing connection, then the sensor package 1404 interrupts the connection with the video display device 1401 such that the video display device 1401 directs video output in a different manner (e.g., the video display device 1401 depicts the video on its own display). Thus, the sensor package 1404 controls the output on the enhanced glasses 1403, 1409 based upon the user's Donned/Doffed state as perceived by the sensor 1405.

In some embodiments of the invention, the video display device 1401 requires no adjustments or additional capabilities beyond the conventional design. Thus, only the enhanced glasses 1403, 1409 require modifications beyond the conventional design in such embodiments. The enhanced glasses' modifications comprise the addition of the sensor 1405, and the sensor package 1404, according to an embodiment of the invention.

The sensor package 1404 comprises a transceiver 1407 and a sensor logic 1408. The transceiver 1407 and the sensor logic 1408 function in a similar manner to the transceiver 1307 and the sensor logic 1305 shown in FIGS. 13A and 13B. The sensor logic 1408 processes data from the Don/Doff sensor 1405 in a manner similar to the logic 402 shown in FIG. 4 for audio data and in accordance with the flowchart 500 shown in FIG. 5, according to an embodiment of the invention. In some embodiments of the invention, the glasses 1403, 1409 may comprise additional capabilities for adjusting glasses parameters themselves (e.g., fine-tuning the user's viewing experience).

Video display may be directed to the enhanced glasses 1403, 1409 automatically based upon the Don/Doff status detected by the sensor 1405, as discussed above. Alternatively, the enhanced glasses 1403, 1409 and/or the video display device 1401 may have a capability for user control that could either enable or disable the automatic direction of video output based upon the detection of the sensor 1405. In yet other embodiments, the enhanced glasses 1403, 1409 and/or the video display device 1401 may have a capability to supplement and/or enhance the processing of data related to the sensor 1405. For example, the enhanced glasses 1403, 1409 might have a user-selectable configuration in which video output continues to be directed to the enhanced glasses 1403, 1409 when the sensor 1405 detects a Doffed state but a characteristic of the output video changes.

In an alternative embodiment of the invention, the video display device 1401 may be configured to control the flow of video information to the enhanced glasses 1403, 1409. In such an embodiment, the sensor 1403 sends the detected Donned/Doffed state to the video display device 1401 and logic functions on the video display device 1401 determine the device's behavior (e.g., the direction of video output). In essence, the sensor logic 1405 is located on the video display device 1402 in such embodiments.

In such an embodiment, the transceiver 1407 relays the Don/Doff state information to a transceiver 1410 on the video display device 1401 (e.g., the Donned state that the enhanced glasses 1403, 1409 is being worn by the user and should receive the output of any video generated by or through the video display device 1402), according to an embodiment of the invention. Similarly, the sensor 1405 also detects when a user has removed, or doffed, the enhanced glasses 1403, 1409 from his head. The sensor package 1404 directs the reporting of this information to the transceiver 1407 on the enhanced glasses 1403, 1409. The transceiver 1407 reports to the transceiver 1410 on the video display device 1401 that the enhanced glasses 1403, 1409 are no longer worn by the user and that the enhanced glasses 1403, 1409 are no longer providing the user with the output of the video display device 1401.

Embodiments of the invention may also be applied to applications related to more than just audio output. For example, embodiments of the invention may also include detection of Don/Doff clip-on microphones. When the donned/doffed state is detected, then the appropriate audio input changes, according to an embodiment of the invention. Alternatively, the organic audio input (e.g., on the mobile phone) may be supplemented by the audio input from the clip-on microphone.

The communication systems may employ a wired connection between the host device and the peripheral device with the communications running through the wire that connects the host device and the peripheral device, according to an alternative embodiment of the invention.

While specific embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims. In general, in the following claims; the terms used should not be construed to limit the invention to the specific embodiments disclosed in the specification, but should be construed to include all systems and methods that operate under the claims set forth hereinbelow. Thus, it is intended that the invention covers the modifications and variations of this invention provided they come within the scope of the appended claims and their equivalents.

We claim:

1. A communication system, comprising:
a peripheral device having a detector configured to provide a detector output indicating a peripheral device donned state or peripheral device doffed state; and
a sensory control application, wherein the sensory control application enables sensory output at the peripheral device responsive to the detector output.

2. The system of claim 1 wherein the sensory control application directs sensory output to a host device that provides the sensory output to the peripheral device.

3. The system of claim 1, wherein the sensory control application enables communication of a receive signal at the peripheral device when detector output indicates a donned state.

4. The system of claim 1, wherein the sensory control application enables sensory output at the peripheral device when detector output indicates a transition from a doffed state to a donned state.

5. The system of claim 1, wherein the peripheral device is wirelessly coupled to a host device that provides the sensory output to the peripheral device.

6. The system of claim 1, wherein the sensory control application resides in a host device that provides the sensory output to the peripheral device.

7. The system of claim 1, further comprising a host device that transmits sensory output in an audio form, wherein the host device comprises one of a mobile phone and a computer, and wherein the peripheral device comprises a headset.

8. The system of claim 7, wherein the sensory control application enables communication of a transmit signal at the peripheral device to the host device when detector output indicates a donned state.

9. The system of claim 7, wherein the sensory control application enables the communication of a receive signal at the host device when detector output indicates a donned state.

10. The system of claim 7, wherein the sensory control application enables communications output at the host device when detector output indicates a transition from a donned state to a doffed state.

11. The system of claim 7 wherein the detector on the headset comprises a capacitive don/doff sensor.

12. The system of claim 1, further comprising a host device that transmits sensory output in a video format, and wherein the peripheral device comprises enhanced eyeglasses configured for viewing the sensory output.

13. The system of claim 12, wherein the sensory control application provides an indication of a doffed state to the host device that causes the host device to alter a video output from a first video format to a second video format.

14. The system of claim 13 wherein the first video format is three-dimensional video output and the second video format is two-dimensional video output.

15. The system of claim 12, wherein the sensory control application provides an indication of a donned state to the host device that causes the host device to alter a video output from a second video format to a first video format wherein the enhanced glasses are configured to display the first video format.

16. The system of claim 15 wherein the first video format is three-dimensional video output and the second video format is two-dimensional video output.

17. The system of claim 12 wherein the detector on the enhanced eyeglasses comprises one of a capacitive don/doff sensor and a touch sensor.

18. The system of claim 1, further comprising a host device that displays sensory output having a first video characteristic, and wherein the peripheral device comprises enhanced eyeglasses configured for viewing the sensory output in a second video characteristic, wherein the sensory control application provides an indication of a doffed state that causes display on the peripheral device to be configured for the second video characteristic.

19. The system of claim 18 wherein the peripheral device comprises one of a single eye screen heads up display and a dual eye screen heads up display.

20. A method of receiving sensory output on a peripheral device from a host device, the method comprising:
determining if the peripheral device is in a donned state or doffed state; and
enabling sensory output at the peripheral device responsive to the peripheral device state.

21. The method of claim 20, further comprising:
directing sensory output to a host device that provides the sensory output to the peripheral device responsive to the peripheral device state.

22. The method of claim 20, further comprising:
enabling sensory output at the peripheral device when the peripheral device is in a donned state.

23. The method of claim 20, further comprising:
enabling sensory output at a host device associated with the peripheral device when the peripheral device is in a doffed state.

24. The method of claim 20, further comprising:
enabling sensory output at the peripheral device when the peripheral device transitions from a doffed state to a donned state.

25. The method of claim 20, further comprising:
enabling sensory output at a host device when the peripheral device transitions from a donned state to a doffed state.

26. The method of claim 20, further comprising:
wirelessly coupling the peripheral device to a host device that provides the sensory output directed towards the peripheral device.

27. The method of claim 20, further comprising:
transmitting sensory output in audio form by a host device to the peripheral device, wherein the host device comprises one of a mobile phone and a computer, and wherein the peripheral device comprises a headset.

28. The method of claim 27, further comprising:
enabling communication of a transmit signal at the peripheral device to the host device when detector output indicates a donned state.

29. The method of claim 27, further comprising:
enabling communication of a receive signal at the host device when detector output indicates a donned state.

30. The method of claim 27, further comprising:
enabling communications at the host device when detector output indicates a transition from a donned state to a doffed state.

31. The method of claim 20, further comprising:
transmitting sensory output in a video format from a host device to the peripheral device, wherein the peripheral device comprises enhanced eyeglasses.

32. The method of claim 31, further comprising:
providing an indication of a doffed state to the host device that causes the host device to alter a video output from a first video format to a second video format.

33. The method of claim 32 wherein the first video format is three-dimensional video output and the second video format is two-dimensional video output.

34. The method of claim 31, further comprising:
providing an indication of a donned state to the host device that causes the host device to alter a video output from a second video format to a first video format wherein the enhanced glasses are configured to display the first video format to a user of the peripheral device.

35. The method of claim 34 wherein the first video format is three-dimensional video output and the second video format is two-dimensional video output.

36. The method of claim 20, further comprising:
displaying sensory output in a first video characteristic from the host device, wherein the peripheral device comprises enhanced eyeglasses configured to display sensory output in a second video characteristic; and
providing an indication of a donned state that causes display on the peripheral device to configured for display of the sensory output in the second video characteristic.

37. The system of claim 36 wherein the peripheral device comprises one of a single eye screen heads up display and a dual eye screen heads up display.
